(19) United States
(12) Patent Application Publication
(10) Pub. No.: US 2007/0198783 A1
(43) Pub. Date: Aug. 23, 2007

(54) Method Of Temporarily Storing Data Values In A Memory

(75) Inventors: Christophe Cunat, Gentilly (FR); Jean Gobert, Alfortville (FR); Yves Mathieu, Yerres (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/568,133

(22) PCT Filed: Apr. 21, 2005
(86) PCT No.: PCT/IB05/51311

§ 371 Date: Oct. 20, 2006

(30) Foreign Application Priority Data
Apr. 26, 2004 (EP) 04300218.7

(51) Int. Cl. G06F 13/00

(52) U.S. Cl. 711/154

(57) ABSTRACT

The present invention relates to a memory management unit (MMU) for storing data values, said memory management unit comprising a memory unit (IM) which is adapted to store temporarily at least two sets of data values; and a controller (CTRL) which is configured such that it is able to store a first set of data values in a first area of the memory unit, and to store a second set of data values spatially adjacent to the first set of data values in a horizontal and/or in a vertical direction in such a way that a first part of the second set of data values is stored in a second area of the memory unit adjacent to the first area in a horizontal and/or in a vertical direction, respectively, and that the other part of the second set of data values to be stored which exceeds the memory unit size in a horizontal and/or in a vertical direction, respectively, is stored in at least one other area of the memory unit according to a torus principle.

### FIELD OF THE INVENTION

The present invention relates to a method of and a device for storing data values in a memory unit.

This invention may be used in portable apparatuses adapted to render graphical objects such as, for example, video decoders, 3D graphic accelerators, video game consoles, personal digital assistants or mobile phones.

### BACKGROUND OF THE INVENTION

Texture mapping is a process for mapping an input image onto a surface of a graphical object to enhance the visual realism of a generated output image including said graphical object. Intricate detail at the surface of the graphical object is very difficult to model using polygons or other geometric primitives, and doing so can greatly increase the computational cost of said object. Texture mapping is a more efficient way to represent fine detail on the surface of the graphical object. In a texture mapping operation, a texture data item of the input image is mapped onto the surface of the graphical object as said object is rendered to create the output image.

In conventional digital images, the input and output images are sampled at discrete points, usually on a grid of points with integer coordinates. The input image has its own coordinate space (u,v). Individual elements of the input image are referred to as “texels”. Said texels are located at integer coordinates in the input coordinate system (u,v). Similarly, the output image has its own coordinate space (x,y). Individual elements of the output image are referred to as “pixels”. Said pixels are located at integer coordinates in the output coordinate system (x,y).

The process of texture mapping conventionally includes filtering texels from the input image so as to compute an intensity value for a pixel in the output image. Conventionally, the input image is linked to the output image via an inverse affine transform T⁻¹.

The output image is made, for example, of a plurality of rectangles also referred to as tiles defined by the positions of their vertices. The tiles of the output image correspond to quadrilateral also referred to as inverse tiles in the input image also defined by the positions of their vertices. Said positions define a unique affine transform between a quadrilateral in the input image and a rectangle in the output image. To generate the output image, each output rectangle is scan-converted to calculate the intensity value of each pixel of the quadrilateral on the basis of intensity values of texels.

FIG. 1 shows a block diagram of a conventional rendering device. Said rendering device is based on a hardware coprocessor realization. This coprocessor is assumed to be part of a shared memory system. A dynamic memory access unit DMA interfaces the coprocessor with an external memory (not represented). A controller CTRL controls the internal process scheduling. An input memory IM contains a local copy of part of the input image. An initialization unit INIT accesses geometric parameters, i.e. the vertices of the different tiles, through the dynamic memory access unit DMA. From said geometric parameters, the initialization unit INIT computes affine coefficients for the scan-conversion process. These affine coefficients are then processed by a rendering unit REN, which is in charge of scan-converting the inverse tiles. The result of the scan-conversion process is stored in a local output memory OM.

The coprocessor further comprises an address memory block AM, an initialization memory InitM and a loading area determination block LAD. In order to fill the input memory IM, the loading area determination block LAD computes texture addresses that are stored and converted into global memory addresses by the address memory block AM. It permits to load from the external memory the relevant area matching the needs for further processing.

However, such a coprocessor performs the rendering on a tile basis. From rendering one tile to the next one, the continuity of the texture needed for geometric transformation is globally assured depending on the tile scan order. But due to memory alignment constraint and filter footprint, the relevant texture area determined by the address memory block AM is extended. As a matter of fact, the whole area determined by the address memory block AM is loaded into the input memory IM. This is not efficient from the point of view of both memory access and power consumption.

### SUMMARY OF THE INVENTION

It is an object of the invention to propose a method of storing data values in a memory unit, which is more efficient both in terms of memory bandwidth and in terms of power consumption.

To this end, the method in accordance with the invention is characterized in that the memory unit is adapted to store temporarily at least two sets of data values and in that said method comprises the steps of:
storing a first set of data values in a first area of the memory unit,
storing a second set of data values spatially adjacent to the first set of data values in a horizontal and/or in a vertical direction in such a way that a first part of the second set of data values is stored in a second area of the memory unit adjacent to the first area in a horizontal and/or in a vertical direction, respectively, and that the other part of the second set of data values to be stored which exceeds the memory unit size in a horizontal and/or in a vertical direction, respectively, is stored in at least one other area of the memory unit according to a torus principle.

As it will be explained in more detail hereinafter, the shared area between successive tiles is not re-accessed from the external memory, as only a second set of data values spatially adjacent to the first set of data values is loaded from an external memory into the memory unit. Moreover, no data collision occurs when reading and writing data in the memory unit, as the memory unit is adapted to store temporarily at least two sets of data values. Finally, the continuity of the data values and of the memory physical addresses is ensured modulo the horizontal and vertical sizes of the memory unit thanks to the storage according to the torus principle. Thus, the method of storing data values is more efficient than the one of the prior art both in terms of memory bandwidth and in terms of power consumption, as the amount of data values loaded from the external memory has been reduced.

According to a first embodiment of the invention, the memory unit is adapted to store temporarily at least four sets of data values, and the other part of the second set of data values comprises a second part which is stored in a bottom left area of the memory unit, a third part which is stored in the top right area of the memory unit and a fourth part which is stored in the top left area of the memory unit.

According to another embodiment of the invention, the memory unit is divided into two sub-parts of equal size, the method further comprising the steps of:
updating a writing memory during a current time cycle so as to indicate in which sub-part of the memory unit the second set of data values is stored,
copying the content of the writing memory at the end of the current time cycle into a read-only memory.

The present invention also relates to a memory management unit implementing such a method, said memory management unit comprising a memory unit which is adapted to store temporarily at least two sets of data values, and a controller which is configured such that it is able to store a first set of data values in a first area of the memory unit, and to store a second set of data values spatially adjacent to the first set of data values in a horizontal and/or in a vertical direction in such a way that a first part of the second set of data values is stored in a second area of the memory unit adjacent to the first area in a horizontal and/or in a vertical direction, respectively, and that the other part of the second set of data values to be stored which exceeds the memory unit size in a horizontal and/or in a vertical direction, respectively, is stored in at least one other area of the memory unit according to a torus principle.

Beneficially, the memory unit is divided into two sub-parts of equal size, said memory management unit further comprising a writing memory which is updated during a current time cycle to indicate in which sub-part of the memory unit the second set of data values is stored, and a read-only memory in which the content of the writing memory is copied at the end of the current time cycle, data values being read out of the memory unit based on the content of said read-only memory.

The present invention also relates to a portable apparatus comprising said memory management unit.

Said invention finally relates to a computer program product comprising program instructions for implementing said method of temporarily storing data values in a memory.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 shows a block diagram of a conventional rendering device;

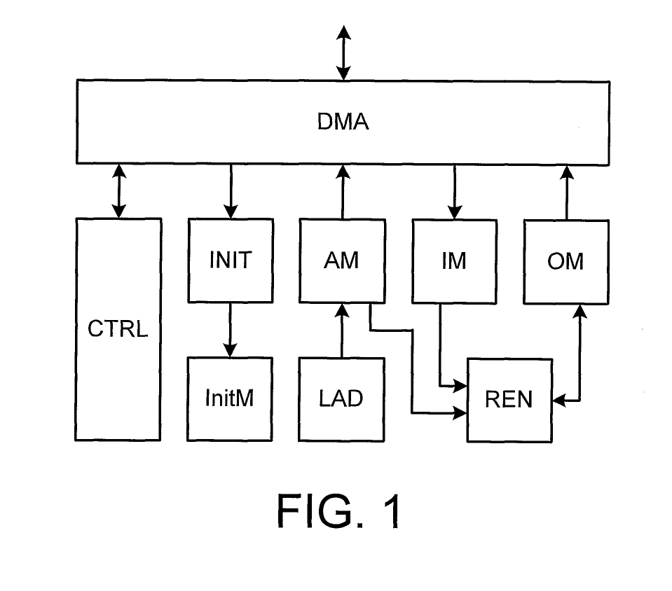

FIG. 2 illustrates a conventional method of texture mapping;

FIG. 3 shows a block diagram of a memory management unit in accordance with the invention;

FIG. 4 illustrates an embodiment of a method of storing data in accordance with the invention; and

FIG. 5 illustrates another embodiment of a method of storing data in accordance with the invention.

### DETAILED DESCRIPTION OF THE INVENTION

The present invention relates to a method of and a device for temporarily storing data. Although the following description is based on the example of texture mapping, this invention is more generally related to systems requiring a local memory refreshment mechanism.

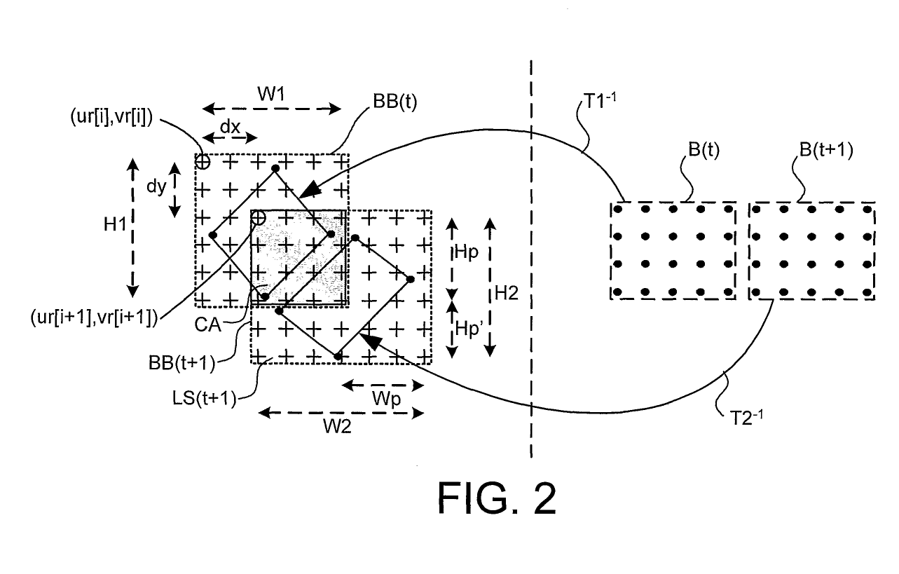

FIG. 2 illustrates a conventional method of texture mapping.

An output image comprises a first tile B(t) to be reconstructed. A first inverse tile BB(t) is associated with the first tile B(t) via a first inverse affine transform T⁻¹. In order to reconstruct the first tile, the texels corresponding to a first bounding box BB(t) are loaded from an external memory into a local memory. Said first bounding box BB(t) has a width W1 and a height H1 and corresponds to the smallest rectangle which includes the first tile B(t).

The output image comprises a second tile B(t+1) to be reconstructed, said second tile being adjacent to the first tile. Similarly, a second inverse tile BB(t+1) is associated with the second tile B(t+1) via a second inverse affine transform T2⁻¹. Similarly, in order to reconstruct the second tile, the texels corresponding to a second bounding box BB(t+1) are loaded from an external memory into a local memory. Said second bounding box BB(t+1) has a width W2 and a height H2, and corresponds to the smallest rectangle which includes the second tile B(t+1).

It can be clearly seen from FIG. 2 that the first bounding box BB(t) and the second bounding box BB(t+1) share a common area CA. Said common area CA can be derived from the shift (dx,dy) of the top left corner of the first bounding box BB(t) having coordinates (ur[i],vr[i]) to the top left corner of the second bounding box BB(t+1) having coordinates (ur[i+1],vr[i+1]). Instead of loading independently and successively from the external memory the contents of the bounding boxes BB(t) and BB(t+1), the present invention proposes to load only an additional area LS(t+1) corresponding to the second bounding box area minus the common area, said additional area being in general L-shaped.

Once the affine coefficients of the inverse affine transforms have been computed, the mapping method in accordance with the invention is adapted to determine, for an output point of a tile, an input transformed point in the corresponding inverse tile using the inverse affine transform. The input transformed point belonging to the inverse tile is in general not located on a grid of texels with integer coordinates. A filtered intensity value corresponding to said input transformed point is then derived according to a step of filtering a set of texels of the inverse tile surrounding said input transformed point. The filtering step is based, for example, on the use of a bilinear filter adapted to implement a bilinear interpolation.

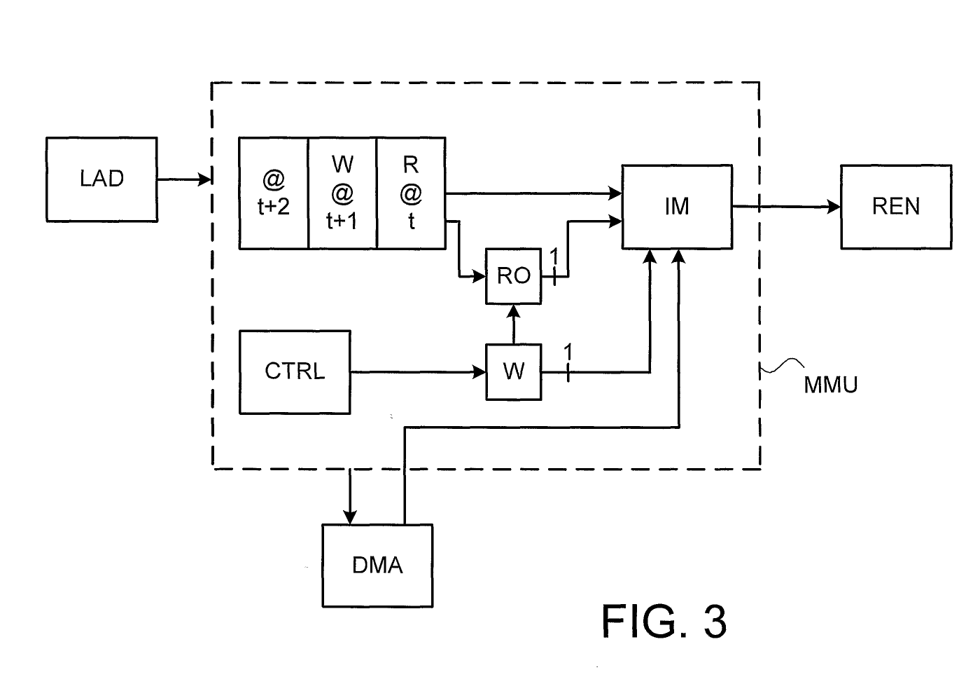

FIG. 3 shows a block diagram of a memory management unit in accordance with the invention. Said memory management unit MMU encapsulates a local input memory IM. Said memory management unit interfaces an external memory through a dynamic memory access unit DMA and further processing blocks requiring accesses to local memory data.

Said memory management unit MMU comprises a memory controller CTRL which is adapted to compute the shift (dx,dy) of an external memory area, corresponding to the second bounding box, from a previous one, corresponding to the first bounding box, and then to determine the L-shaped area as defined in FIG. 2. Said L-shaped area is then loaded from the external memory into the local input memory IM. This controller CTRL maintains an internal physical space coordinates system and performs the conversion between this internal physical space system, the external memory space system and the internal logical space system used by other processing blocks.

In order to fill the input memory IM, a loading area determination block LAD computes texture addresses that are stored in an address memory block of the FIFO (for first in first out) type. According to an embodiment of the invention, said FIFO memory can be seen at a given time as being divided in three parts, the first part (@t+2) containing texture addresses to be rendered during a time cycle t+2; the second part (W@t+1) containing texture addresses to be written in the input memory during a time cycle t so as to be read out and processed during a time cycle t+1; and the third part (R@t) containing texture addresses to be read out and processed during a time cycle t.

As described before, the controller CTRL first determines the area shift (dx,dy) from one bounding box to the next one in order to determine the L-shaped area LS(t+1) to be loaded from the external memory into the local input memory IM. Considering rectangular areas, this shift is determined by the top left corner (ur[i+1],vr[i+1]) of the rectangle which represent the new origin of the internal logical space system. As shown in FIG. 2, said L-shaped area is defined by a partial width Wp and two partial heights Hp and Hp′, meaning that Wp texel values (3 in the example of FIG. 2) needs to be loaded from the external memory for the first Hp lines (4 in our example) and W2 texel values (7 in our example) needs to be loaded from the external memory for the Hp′ subsequent lines (2 in our example).

Using the area shift, the correspondence between the new logical origin and the internal physical coordinates is performed. As it will be seen in more detail hereinafter, the internal physical space system can be seen as a torus where the address are automatically wrapped around when reaching the border of the local input memory IM. The size of said local input memory IM is chosen such that the data values of the L-shaped area LS(t+1) do not overwrite the data values of the bounding box BB(t) during a time cycle t. The memory management unit thus ensures that no data collision occurs and that the continuity of the data values and of the memory physical addresses is ensured modulo the horizontal and vertical sizes of the local input memory IM.

As described before, the L-shaped area LS(t+1) is loaded from the external memory into the local input memory IM while the previous area BB(t) stored in the local input memory IM is accessed for rendering purpose according to a well-known pipeline process. For this purpose, the local input memory IM is a double-port memory.

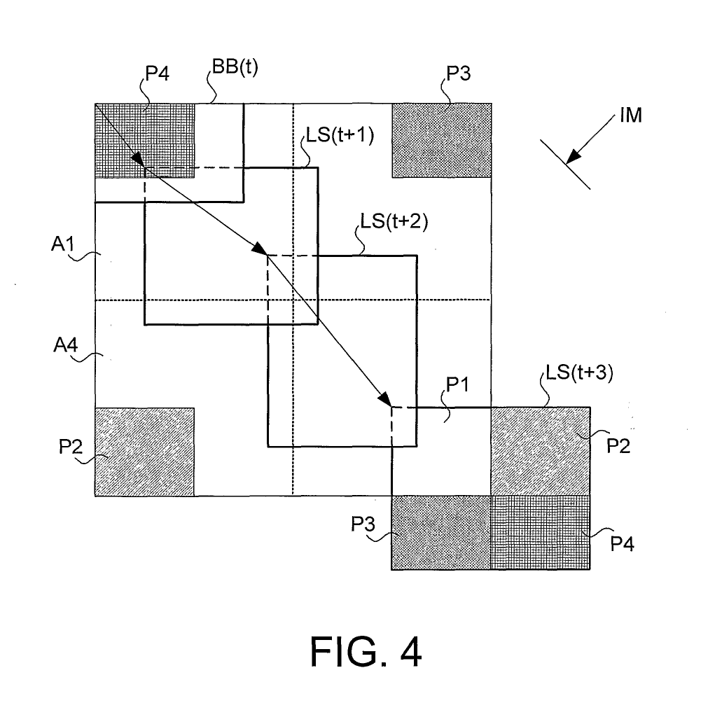

According to an embodiment of the invention, a local input memory four times larger than the memory necessary to store any bounding box is used so that no data collision happens, as illustrated in FIG. 4. For example, if a tile is a square of 16×16 pixels, the bounding box corresponding to an inverse tile will not be larger than 23×23 pixels (the first integer higher than 16√2) using an affine transform. If each pixel comprises 4 components (luminance Y, chrominances U and V, transparency a), each component comprising 8 bits, the minimum size of the memory required to store any bounding box will thus be equal to 23×23 words of 32 bits, and the size of the local input memory will be equal to 46×46 words of 32 bits. It is to be noted that said size can be doubled if a zoom out function is used for rendering.

FIG. 4 illustrates a method of storing data using a local input memory IM four times larger than the memory necessary to store any bounding box, dotted lines showing the virtual separation of said local input memory into 4 equal-size sub-parts A1 to A4.

During a time cycle t−1, a first bounding box BB(t) has been stored in the local input memory IM.

During a time cycle t, a first L-shaped area LS(t+1) is loaded into the local input memory IM, said first L-shaped area fitting in said memory. During this time cycle t, the content of the first bounding box BB(t) is accessed for rendering purpose.

During a time cycle t+1, a second L-shaped area LS(t+2) is loaded into the local memory IM, said second L-shaped area still fitting in the local input memory. During this time cycle t+1, the content of a second bounding box BB(t+1), including the first L-shaped area LS(t+1) and the area common to the first bounding box BB(t) and said second bounding box BB(t+1), is accessed for rendering purpose.

During a time cycle t+2, a third L-shaped area LS(t+3) is loaded into the local input memory IM, only a first part P1 of said third L-shaped area fitting in the fourth area A4 of said local input memory. The other parts of the third L-shaped area are stored in the local input memory according to a torus principle as follows. A second part P2 of the third L-shaped area is stored in the bottom left corner of the third area A3. A third part P3 of the third L-shaped area is stored in the top right corner of the second area A2. Finally, a fourth part P4 of the third L-shaped area is stored in the top left corner of the first area A4. This storage process is iterated until the picture or the complete sequence of pictures has been processed. During this time cycle t+2, the content of the third bounding box BB(t+2) is accessed for rendering purpose.

The memory size increase can be limited to two times the size of the memory necessary to store any bounding box, using a double-buffer memory combined with two binary memories. FIG. 3 illustrates this other embodiment of the method of storing data in accordance with the invention.

When reading the double-buffer memory IM, a read-only memory RO indicates in which part of the double-buffer memory the data is available. When writing the L-shaped area LS(t+1) from the external memory into the double-buffer memory during a time cycle t, a writing memory W is updated so as to indicate in which part of the double-buffer memory IM the writing is performed. At the end of the time cycle t, the content of the writing memory W is copied into the read-only memory RO in order to be used for reading the bounding box BB(t+1) during time cycle t+1. These memories RO and W are only a single bit per memory slot.

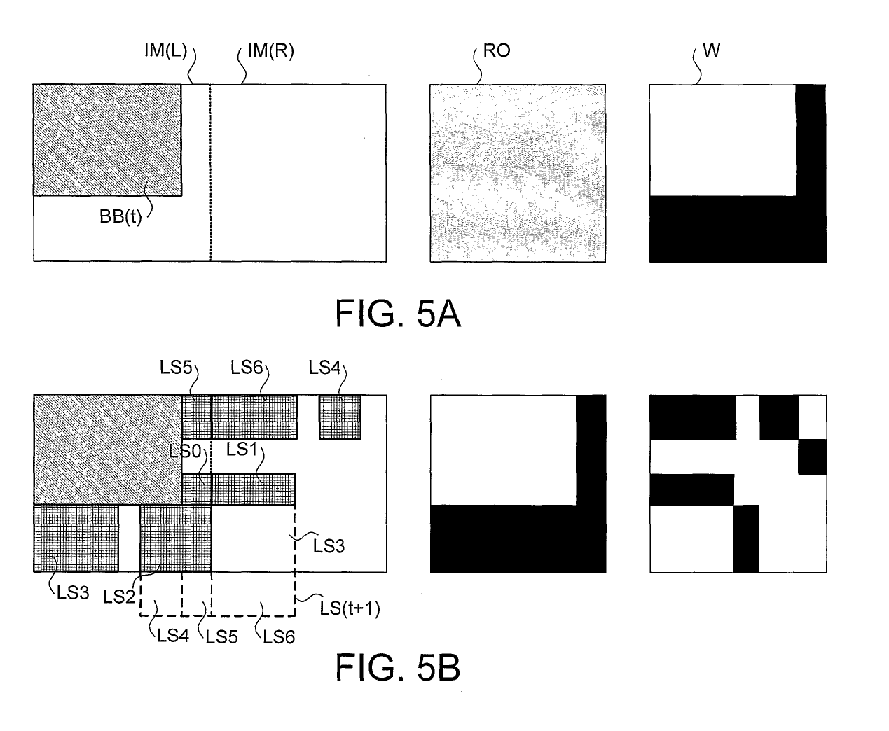

FIG. 5 illustrates this other embodiment of the method of storing data in accordance with the invention in more detail. A dotted line shows the virtual separation of the double-buffer memory IM into 2 equal-size sub-parts IM(R) and IM(L).

During a time cycle t−1, the content of the first bounding box BB(t) has been loaded from the external memory through the dynamic memory access unit DMA into the left part IM(L) of the double-buffer memory IM. The values of the writing memory W have been set to 1 (white part) when data of the first bounding box have been loaded via the dynamic memory access unit DMA into the double-buffer memory. As shown in FIG. 5A, said first bounding box fits in said left part IM(L). At the end of the writing process, the content of the writing memory W is copied into the read-only memory RO for the next processing step.

During a time cycle t, the content of the first bounding box BB(t) is read out from the double-buffer memory IM based on the binary values stored in the read-only memory RO. As shown in FIG. 5B, if the output of the read-only memory RO is equal to 1 (white part), data are read out of the left part IM(L) of the double-buffer memory IM and if the output of the read-only memory RO is equal to 0 (black part), data are read out of the right part IM(R) of the double-buffer memory IM.

During said time cycle t, the content of the L-shaped area LS(t+1) is loaded from the external memory through the dynamic memory access unit DMA into the double-buffer memory IM. Each time a data item has to written in the double-buffer memory IM, the corresponding bit of the writing memory W is reversed (from 1 to 0 or from 0 to 1) so as to be sure the write said data item in the appropriate memory part. In the example of FIG. 5B, the values of the writing memory W are set to 1 (white part) when a data item is loaded from the external memory into the left part IM(L) of the double-buffer memory, and the values of the writing memory W are set to 0 (black part) when a data item is loaded from the external memory into the right part IM(R) of the double-buffer memory. As a consequence, data are stored in the double-buffer memory according to a torus principle, as follows:
if there are memory slots which are not occupied by the bounding box BB(t), data are stored in the left part IM(L) (see FIG. 5B: LS0, LS2, LS3 and LS5)
if there is no place available in said left part IM(L) because the corresponding area is filled with the first bounding box BB(t), data are stored in the right part IM(R) of the double buffer memory at a same location they would have been stored in the left part IM(L) if said location has been available (see FIG. 5B: LS1, LS4 and LS6).
   At the end of the writing process, the content of the writing memory W is copied into the read-only memory RO for the next processing step.

The process is iterated until the picture or the complete sequence of pictures has been processed.

Several embodiments of the present invention have been described above by way of examples only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. A method of storing data values in a memory unit (IM) which is adapted to store temporarily at least two sets of data values (BB(t),LS(t+1);BB(t+2),LS(t+3)), said method comprising the steps of:
storing a first set of data values (BB(t);BB(t+2)) in a first area of the memory unit,
storing a second set of data values (LS(t+1);LS(t+3)) spatially adjacent to the first set of data values in a horizontal and/or in a vertical direction in such a way that a first part (P1;LS0,LS1,LS2) of the second set of data values is stored in a second area of the memory unit adjacent to the first area in a horizontal and/or in a vertical direction, respectively, and that the other part (P2,P3,P4;LS3,LS4,LS5,LS6) of the second set of data values to be stored which exceeds the memory unit size in a horizontal and/or in a vertical direction, respectively, is stored in at least one other area of the memory unit according to a torus principle.

2. A method as claimed in claim 1, wherein the memory unit is adapted to store temporarily at least four sets of data values, and wherein the other part of the second set of data values comprises a second part (P2) which is stored in a bottom left area of the memory unit, a third part (P3) which is stored in the top right area of the memory unit and a fourth part (P4) which is stored in the top left area of the memory unit.

3. A method as claimed in claim 1, wherein the memory unit (IM) is divided into two sub-parts of equal size (IM(L),IM(R)), said method further comprising the steps of:
updating a writing memory (W) during a current time cycle so as to indicate in which sub-part of the memory unit the second set of data values is stored,
copying the content of the writing memory at the end of the current time cycle into a read-only memory (RO).

4. A memory management unit (MMU) for storing data values, said memory management unit comprising:
a memory unit (IM) which is adapted to store temporarily at least two sets of data values (BB(t),LS(t+1);BB(t+2),LS(t+3)),
a controller (CTRL) which is configured such that it is able to store a first set of data values (BB(t);BB(t+2)) in a first area of the memory unit, and to store a second set of data values (LS(t+1);LS(t+3)) spatially adjacent to the first set of data values in a horizontal and/or in a vertical direction in such a way that a first part (P1;LS0,LS1,LS2) of the second set of data values is stored in a second area of the memory unit adjacent to the first area in a horizontal and/or in a vertical direction, respectively, and that the other part (P2,P3,P4; LS3,LS4,LS5,LS6) of the second set of data values to be stored which exceeds the memory unit size in a horizontal and/or in a vertical direction, respectively, is stored in at least one other area of the memory unit according to a torus principle.

5. A memory management unit (MMU) as claimed in claim 4, wherein the memory unit is divided into two sub-parts of equal size (IM(L),IM(R)), said memory management unit (MMU) further comprising:
a writing memory (W) which is updated during a current time cycle to indicate in which sub-part of the memory unit the second set of data values is stored;
a read-only memory (RO) in which the content of the writing memory is copied at the end of the current time cycle, data values being read out of the memory unit based on the content of said read-only memory.

6. A portable apparatus comprising a memory management unit (MMU) as claimed in claim 4.

7. A computer program product comprising program instructions for implementing, when said program is executed by a processor, a method as claimed in claim 1.
